(19) United States
(12) Patent Application Publication
(10) Pub. No.: US 2010/0077189 A1
(43) Pub. Date: Mar. 25, 2010

(54) COMPUTER SYSTEM HAVING MUSIC PLAYING FUNCTION

(75) Inventors: CHUN-WEI LEE, Tu-Cheng (TW); PING-KUN LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/251,402

(22) Filed: Oct. 14, 2008

(30) Foreign Application Priority Data
Sep. 19, 2008 (CN) 200810304565.3

(51) Int. Cl. G06F 9/00

(52) U.S. Cl. 713/1

(57) ABSTRACT

A computer system includes an input output (I/O) device, an I/O control chip, an audio file processing unit, an audio interface, an audio chip, and a power supply. The I/O control chip is configured for receiving a music playing command from the I/O input device, and outputting an audio control signal according to the music playing command. The audio file processing unit stores audio files, and receives the audio control signal to read a corresponding audio file and output an audio processing signal. The audio interface is configured for connecting to an audio device. The audio chip is configured for receiving and processing the audio file according to the audio processing signal, and outputting an audio signal to the audio interface. The power supply supplies standby power to the I/O control chip, the audio file processing unit, and the audio chip when the computer system is not booted up.

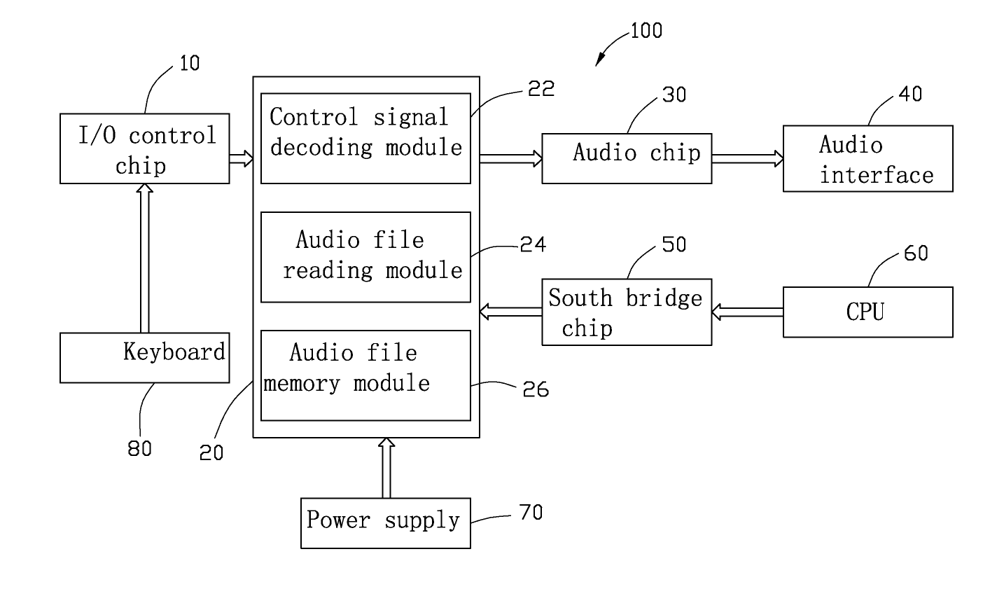

### BACKGROUND

1. Field of the Disclosure

The present disclosure relates to computer systems and, particularly, to a computer system capable of playing music when the computer system is not booted up.

2. Description of Related Art

Nowadays, computer systems are widely used in many fields. When a user wants to listen to music via a computer system, the user must first boot up the computer system, and then open a music file to listen to the music. However, this method wastes time and electricity, and is inconvenient.

What is needed is to provide a computer system that can play music when the computer is not booted up.

### BRIEF DESCRIPTION OF THE DRAWING

The drawing is a block diagram of an embodiment of a computer system.

### DETAILED DESCRIPTION OF THE EMBODIMENTS

Referring to the drawing, an embodiment of a computer system 100 includes an input output (I/O) control chip 10, an audio file processing unit 20, an audio chip 30, an audio interface 40, a memory controller such as a south bridge chip 50, a central processing unit (CPU) 60, a power supply 70, and an I/O input device such as a keyboard 80. In one embodiment, the I/O input device may be a mouse.

When the computer system 100 is booted up, the power supply 70 supplies main power and standby power to all elements of the computer system 100. When the computer system 100 is not booted up, the power supply 70 only supplies standby power to the I/O control chip 10, the audio file processing unit 20, and the audio chip 30.

The audio file processing unit 20 includes a control signal decoding module 22, an audio file reading module 24, and an audio file memory module 26.

The audio file memory module 26 is configured for storing audio files, such as MP3 and WMA files. When the computer system 100 is turned on, users can copy audio files from a hard disk drive (HDD) to the audio file memory module 26 via the CPU 60 and the south bridge chip 50 by function of an operation system, such as Window XP. Users also can store the audio files directly to the audio file memory module 26 via other methods according to need.

When the computer system 100 is not booted up, the I/O control chip 10 is configured for receiving a music playing command from the keyboard 80, such as pressing the down arrow key of the keyboard 80 for playing the next audio file according to a pre-established queuing order of the audio files, and outputting an audio control signal to the control signal decoding module 22 according to the music playing command.

The control signal decoding module 22 is configured for decoding the control signal from the I/O control chip 10, and outputting an audio reading signal to the audio file reading module 24 and outputting an audio processing signal to the audio chip 30.

The audio file reading module 24 is configured for reading a corresponding audio file, according to the audio reading signal, and outputting the audio file to the audio chip 30.

The audio chip 30 is configured for receiving and processing the audio file, performing a function on the file such as play and advance, and outputting an audio signal to the audio interface 40. Users can use an audio device such as an headphone connected to the audio interface 40 to listen to the audio file.

It is to be understood, however, that even though numerous characteristics and advantages of the present disclosure have been set forth in the foregoing description, together with details of the structure and function of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A computer system comprising:
an input output (I/O) device;
an I/O control chip configured for receiving a music playing command from the I/O input device, and outputting an audio control signal according to the music playing command;
an audio file processing unit storing audio files, and configured for receiving the audio control signal to read a corresponding audio file and output an audio processing signal;
an audio interface configured for connecting to an audio device;
an audio chip configured for receiving and processing the audio file according to the audio processing signal, and outputting an audio signal to the audio interface; and
a power supply supplying standby power to the I/O control chip, the audio file processing unit, and the audio chip when the computer system is not booted up.

2. The computer system of claim 1, wherein the audio file processing unit comprises:
a control signal decoding module configured for decoding the audio control signal from the I/O control chip and outputting an audio reading signal;
an audio file reading module configured for reading the corresponding audio file according to the audio reading signal, and outputting the audio file to the audio chip; and
an audio file memory module configured for storing the audio files.

3. The computer system of claim 1, further comprising a central processing unit (CPU) and a memory controller, wherein upon a condition that the computer system is booted up, audio files are capable of being copied from a hard disk drive (HDD) to the audio file memory module via the CPU and the memory controller.

4. The computer system of claim 3, wherein the memory controller is a south bridge chip.

5. The computer system of claim 1, wherein the I/O input device is a keyboard.

6. The computer system of claim 1, wherein the I/O input device is a mouse.
